(19) United States
(12) Patent Application Publication
(10) Pub. No.: US 2026/0364966 A1
(43) Pub. Date: Nov. 19, 2026

(54) POSITIONING TOOL ASSEMBLY FOR STAMPS AND STENCILS

(71) Applicant: Tasnim Ahmed, Jamesville, NY (US)

(72) Inventor: Tasnim Ahmed, Jamesville, NY (US)

(21) Appl. No.: 19/750,146

(22) Filed: Jul. 22, 2026

Related U.S. Application Data
(63) Continuation-in-part of application No. 19/056,145, filed on Feb. 18, 2025, now Pat. No. 12,709,111.

(51) Int. Cl. B41K 3/62

(52) U.S. Cl. CPC B41K 3/62

(57) ABSTRACT

A positioning tool assembly for accurately positioning a stamp, stencil, or other image-transfer member relative to an artistic medium is disclosed. The assembly includes a base defining a working area and a platform extending at least partially around the working area. The platform may include one or more removable side members that permit selective expansion of the working area and accommodate artistic media and image-transfer members of different sizes. A mounting film, such as a tacky photopolymer film or adhesive mat, is configured to be supported on the base for releasably retaining the artistic medium. A plurality of alignment tabs is provided on the platform for repeatably positioning a flip plate relative to the base. The flip plate is configured to releasably retain a stamp and to be repeatedly repositioned in substantially the same location to facilitate accurate registration and repeated impressions.

### CROSS REFERENCE TO RELATED APPLICATIONS

This application is a continuation-in-part of a U.S. patent application Ser. No. 19/056,145, filed on Feb. 18, 2025, which is incorporated herein by reference in its entirety.

### FIELD OF INVENTION

The present invention relates generally to assemblies for positioning stamps and stencils relative to an artistic medium, and more particularly, to a positioning assembly configured to accurately position a stamp, such as a photopolymer stamp, or a stencil on an artistic medium.

### BACKGROUND

Stamping is a widely used technique for transferring decorative patterns, images, text, or other indicia onto an artistic medium, such as paper, cardstock, greeting cards, scrapbook pages, fabric, or other printable substrates. Typically, a stamp includes a raised pattern formed from a resilient material, such as rubber, silicone, acrylic, or photopolymer. Ink or another coloring medium is applied to the raised pattern, after which the stamp is pressed against the artistic medium to transfer the desired image.

Photopolymer and acrylic stamps are commonly used in arts and crafts due to their transparency, ease of handling, and availability in numerous designs. In particular, photopolymer stamps are capable of producing sharp, crisp, and highly detailed impressions, making them popular for decorative and precision stamping applications.

Various stamping platforms and positioning tools have been developed to assist users in aligning a stamp with an intended location on an artistic medium. Nevertheless, accurately positioning a stamp remains challenging, particularly when the stamped image must be aligned with previously printed graphics, other stamped images, or predetermined guide markings.

Furthermore, a first stamping operation may occasionally produce an incomplete or uneven impression because of insufficient ink coverage, non-uniform pressure, or movement of the stamp during application. In such situations, the stamp often needs to be reapplied at precisely the same location. However, manually repositioning the stamp at the exact previous location is difficult and may result in image misalignment, ghosting, or double impressions.

Similar positioning challenges are encountered when using stencils for applying inks, paints, pigments, embossing media, or other decorative materials. Even slight displacement of a stencil during repeated applications may adversely affect the quality and accuracy of the resulting artwork.

Accordingly, there exists a need for an improved positioning tool assembly capable of accurately locating and repeatedly repositioning a stamp or stencil relative to an artistic medium, thereby facilitating consistent alignment, repeatable impressions, and improved ease of use.

### SUMMARY OF THE INVENTION

The following presents a simplified summary of one or more embodiments of the present invention to provide a basic understanding of certain features and advantages thereof. This summary is not an exhaustive overview of all contemplated embodiments and is not intended to identify key or critical elements of the invention or to delineate the scope of the claims. Rather, it introduces selected concepts that are further described in the detailed description.

Accordingly, it is an object of the present invention to provide a positioning tool assembly for accurately positioning a stamp or stencil relative to an artistic medium.

It is another object of the present invention to provide a positioning tool assembly that accommodates artistic media of different sizes and dimensions.

It is another object of the present invention to provide a positioning tool assembly that facilitates repeatable alignment of a stamp or stencil for successive applications.

It is another object of the present invention to provide a positioning tool assembly that permits stamps of varying sizes, including relatively large stamps, to be used in multiple orientations.

It is another object of the present invention to provide a positioning tool assembly that accommodates relatively large artistic media without requiring trimming or resizing.

It is yet another object of the present invention to provide a positioning tool assembly that is simple in construction, convenient to use, durable, and economical to manufacture.

Disclosed is a positioning tool assembly configured to accurately and repeatably position a stamp, stencil, or other image-transfer member relative to an artistic medium. The positioning tool assembly includes a base defining a working area and a platform extending at least partially around the working area. In certain embodiments, the platform includes a plurality of removable side members that may be selectively removed to increase accessibility to the working area or to accommodate artistic media and image-transfer members of different sizes.

In one embodiment, the base is configured to support a mounting film, such as a tacky photopolymer film or adhesive mat, adapted to releasably retain an artistic medium during stamping, stenciling, scoring, or other crafting operations. One or more alignment indicia may be provided on the mounting film, the base, or both to facilitate positioning of the artistic medium.

In certain embodiments, the platform includes a plurality of alignment tabs configured to cooperate with a flip plate. The flip plate is movable relative to the platform and is configured to releasably retain a stamp, such as a photopolymer stamp, enabling the stamp to be repeatedly returned to substantially the same position relative to the artistic medium. Such repeatable positioning facilitates improved registration and repeated impressions while reducing image misalignment.

In certain embodiments, the base further includes an integral score board having one or more scoring grooves configured to facilitate formation of score lines in an artistic medium. The score board enables scoring operations to be performed using the same workspace employed for stamping and stenciling.

In certain embodiments, one or more extension pieces are removably attachable to the base after removal of corresponding side members, thereby increasing the effective working area of the positioning tool assembly. The removed side members may be repositioned on outer portions of the extension pieces, or the extension pieces may include corresponding platform or alignment features. One or more extended flip plates may be provided for use with the extension pieces to maintain accurate positioning over the expanded working area.

The modular construction of the positioning tool assembly permits selective reconfiguration of the workspace according to the size and orientation of the artistic medium, the stamp, the stencil, or other crafting components. The assembly thereby accommodates relatively large artistic media without requiring trimming and facilitates the use of relatively large stamps and stencils in multiple orientations.

The disclosed positioning tool assembly may be used in stamping, stenciling, scoring, embossing, and other artistic or paper-crafting operations. The assembly provides improved alignment accuracy, repeatable positioning, workspace flexibility, and ease of use while reducing the need for multiple separate crafting tools.

These and other features, aspects, and advantages of the present disclosure will become more apparent from the following detailed description taken in conjunction with the accompanying drawings.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a top view of a frame of the positioning tool assembly, according to an exemplary embodiment of the present invention.

FIG. 2 shows a base of the frame, according to an exemplary embodiment of the present invention.

FIG. 3 shows four side members of the frame removed from the base, according to an exemplary embodiment of the present invention.

FIG. 4 shows a mounting film of the positioning tool assembly, according to an exemplary embodiment of the present invention.

FIG. 5 shows a flip plate of the positioning tool assembly, according to an exemplary embodiment of the present invention.

FIG. 6 shows a top view of the positioning tool assembly, according to an exemplary embodiment of the present invention.

FIG. 7 illustrates the stamping process using the positioning tool assembly, according to an exemplary embodiment of the present invention.

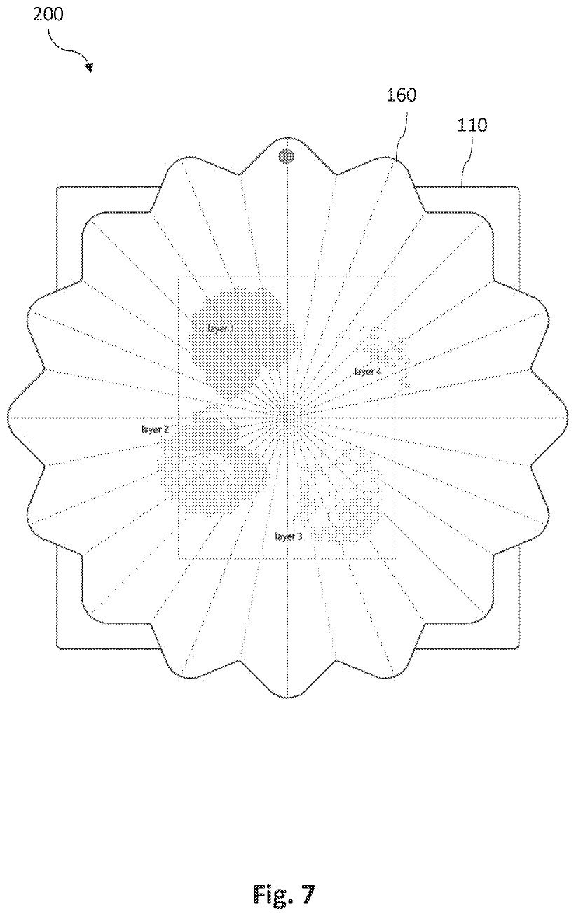

FIG. 8 shows coupling mechanism for securing a side member to the base, according to an exemplary embodiment of the present invention.

FIG. 9 shows the bottom side of the base and pegs of the side member, according to an exemplary embodiment of the present invention.

FIG. 10 shows an extension piece coupled to the base, according to an exemplary embodiment of the present invention.

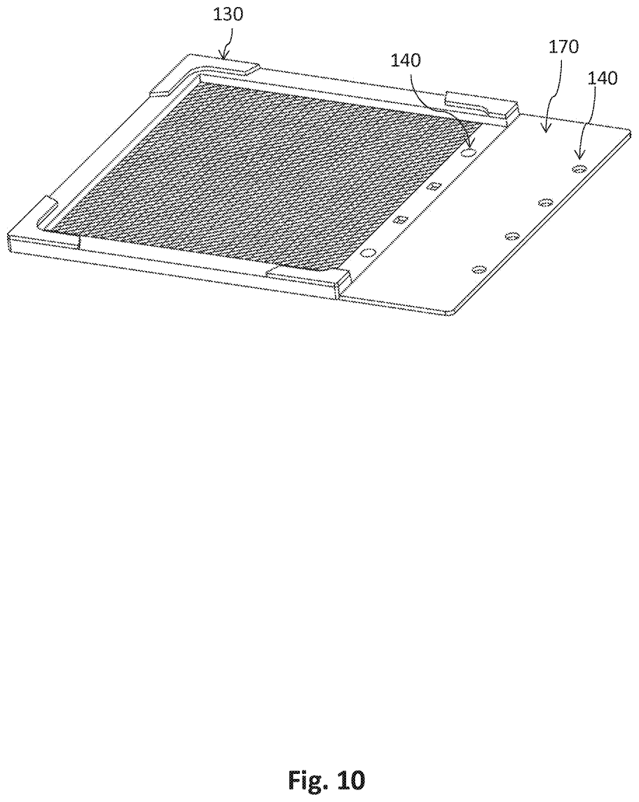

FIG. 11 shows an extended flip plate of the positioning tool assembly, according to an exemplary embodiment of the present invention.

FIG. 12 is a top view showing the extended flip plate positioned over the positioning tool with extension, according to an exemplary embodiment of the present invention.

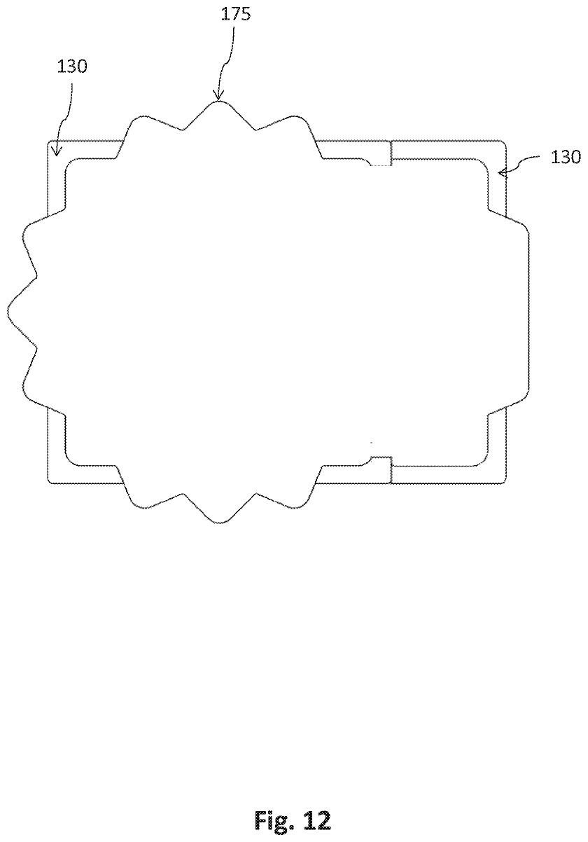

FIG. 13 is a perspective view of FIG. 12, according to an exemplary embodiment of the present invention.

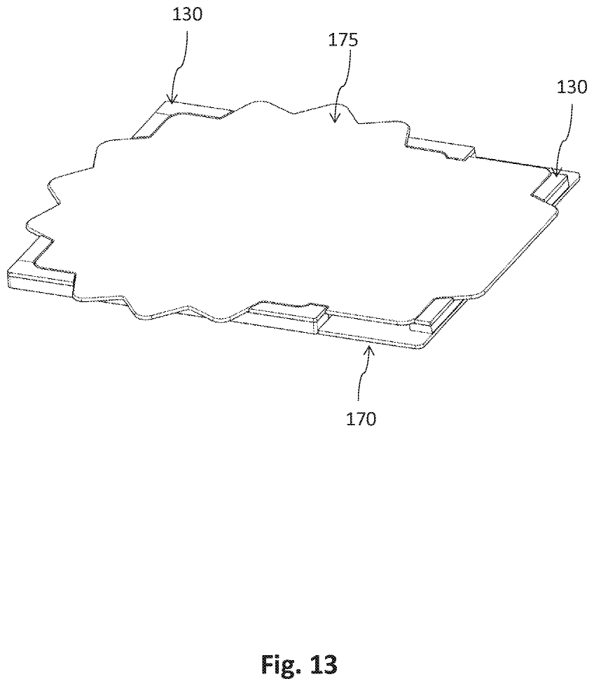

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

The present disclosure pertains to a positioning tool assembly for positioning a stamp or stencil relative to an artistic medium. Although stamping tools are widely used in arts and crafts for transferring inked patterns, images, text, or other indicia onto artistic media, accurately positioning such stamping tools can be challenging, particularly when repeated impressions or precise alignment are desired. The disclosed positioning tool assembly facilitates accurate, repeatable, and convenient positioning of a stamp or stencil relative to the artistic medium.

The positioning tool assembly is versatile and may be used with artistic media of various sizes, shapes, and thicknesses. The assembly may be selectively configured or customized to accommodate different project requirements, thereby providing a flexible workspace suitable for a wide range of paper crafting and artistic applications. Artistic media of different sizes, including relatively large sheets, may be positioned in a desired layout and orientation without requiring trimming. Likewise, stamps and stencils of various sizes, including relatively large stamps, may be used in multiple orientations within the workspace.

In certain embodiments, the positioning tool assembly further includes an integrated scoring board configured to form score lines on the artistic medium, thereby reducing or eliminating the need for a separate scoring tool or scoring board. Accordingly, the disclosed positioning tool assembly provides a multifunctional workspace that supports stamping, stenciling, scoring, and related crafting operations using a single platform.

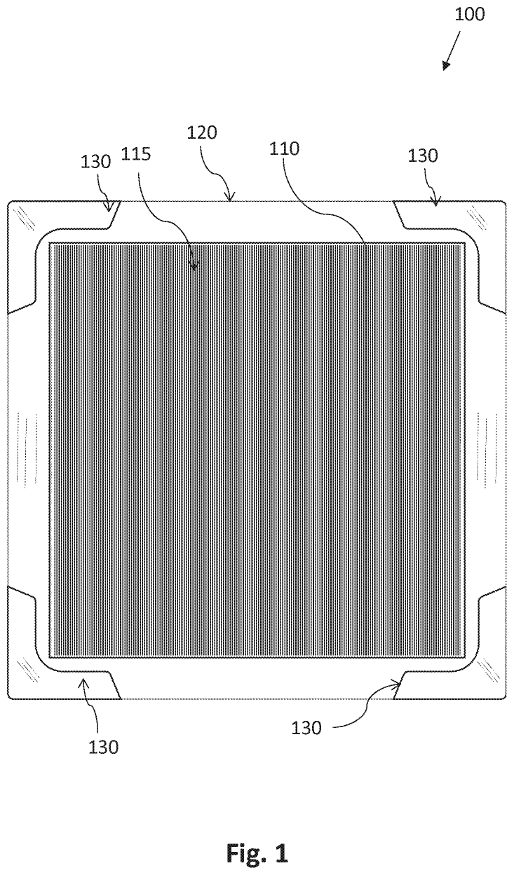

Referring to FIG. 1, shown is a top view of an exemplary frame 100 of the disclosed positioning tool assembly. The frame 100 includes a generally planar base 110 configured to support an artistic medium during stamping, stenciling, scoring, or related crafting operations. In the illustrated embodiment, the base 110 is generally square. However, it will be appreciated that the base 110 may have any suitable shape, including, without limitation, rectangular, circular, oval, polygonal, or other regular or irregular configurations, without departing from the scope of the present disclosure.

The dimensions of the base 110 may be selected to accommodate artistic media of one or more standard or non-standard sizes. Preferably, the base 110 defines a working surface having dimensions greater than those of the artistic medium to provide adequate support and positioning space. Suitable artistic media include, without limitation, paper, cardstock, greeting cards, invitation cards, business cards, scrapbook pages, envelopes, labels, tags, fabric, or other printable or craft substrates.

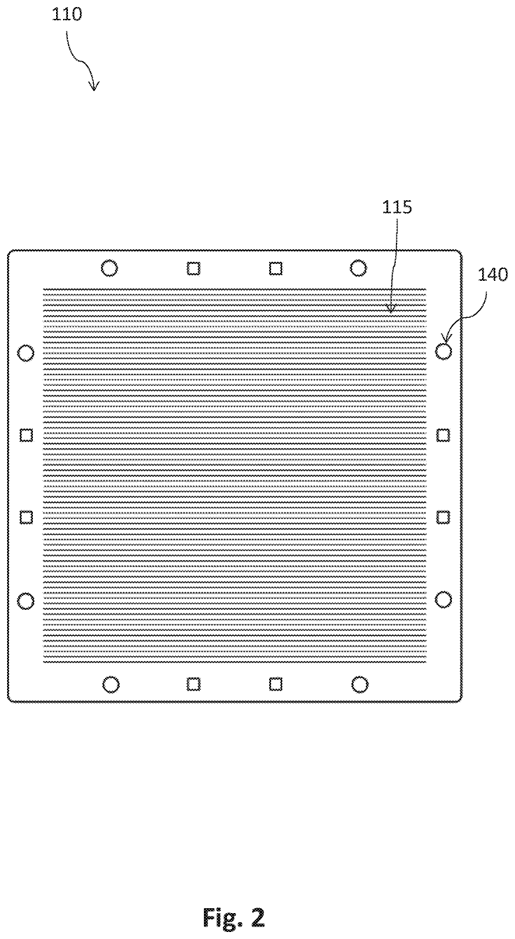

In certain embodiments, the base 110 further includes an integral scoring board 115, as illustrated in FIG. 2. The scoring board 115 is configured to facilitate the formation of score lines in the artistic medium, such as paper or cardstock, thereby enabling accurate folding operations. One or more measurement scales, rulers, alignment markings, or indicia may be provided adjacent to the scoring board 115 to assist in positioning the artistic medium and determining score locations.

In one embodiment, the scoring board 115 includes a plurality of elongated grooves extending generally parallel to one another. To form a score line, the artistic medium may be positioned on the scoring board 115, and a scoring implement, such as a handheld tool having a rounded or smooth tip formed from plastic, metal, or another suitable material, may be drawn along a selected groove to create an indentation in the artistic medium. The resulting score line facilitates controlled folding while reducing the likelihood of cracking or tearing the material.

Although an integral scoring board 115 is illustrated, it will be understood that the scoring board may be omitted, removably attached, interchangeably mounted, or otherwise incorporated into the positioning tool assembly without departing from the scope of the present disclosure.

Referring again to FIG. 1, the base 110 may be at least partially surrounded by a platform 120 extending generally along the periphery of the base 110. In the illustrated embodiment, the platform 120 has a generally square peripheral configuration and includes an upper support surface. However, the platform 120 may have any suitable shape corresponding to the shape of the base 110, including rectangular, circular, oval, polygonal, or other configurations.

The platform 120 is spaced above the base 110 by a predetermined height to define a recessed working area for receiving one or more layers, including an artistic medium, a stamp or stencil, and, where applicable, a photopolymer mounting film or other mounting substrate. The height of the platform 120 relative to the base 110 may be selected to substantially correspond to the combined thickness of the components positioned within the recessed working area so that an upper surface of the stamp or stencil is substantially flush with, or at a desired elevation relative to, the upper support surface of the platform 120.

In embodiments utilizing photopolymer stamps, the predetermined height of the platform 120 may be selected based on one or more standard thicknesses of commercially available photopolymer stamps and associated mounting films. It will be appreciated, however, that the platform height may be varied to accommodate stamps, stencils, mounting members, and artistic media of different thicknesses.

In certain embodiments, one or more spacer sheets, filler sheets, shims, or inserts may be positioned within the recessed working area to compensate for variations in the combined thickness of the artistic medium, mounting film, stamp, or stencil. Such spacer members enable the positioning tool assembly to accommodate components of different thicknesses while maintaining a desired working height and positioning accuracy.

Referring again to FIG. 1, a plurality of alignment tabs 130 may be provided on the platform 120. In the illustrated embodiment, four alignment tabs 130 are positioned adjacent the respective corners of the platform 120. However, it will be appreciated that the number, size, shape, and locations of the alignment tabs 130 may be varied without departing from the scope of the present disclosure.

Each alignment tab 130 may include an upstanding wall extending from the platform 120 and defining an inwardly facing alignment surface configured to engage or locate an artistic medium, an alignment accessory, or another component of the positioning tool assembly.

In one embodiment, the inward facing surface of each alignment tab 130 includes a curved end portion. Such a configuration facilitates placement and removal of the flip plate. It will be understood, however, that the alignment tabs 130 may include straight, curved, angled, radiused, beveled, or other surface configurations.

The width of each alignment tab 130 may be less than the width of the platform 120, thereby leaving exposed portions of the platform for accommodating the flip plate.

In certain embodiments, the platform 120 is removably coupled to the base 110 such that the platform 120 may be detached from and reattached to the base 110 as desired. The removable construction enables the positioning tool assembly to be selectively reconfigured for different artistic media, stamps, stencils, and crafting operations.

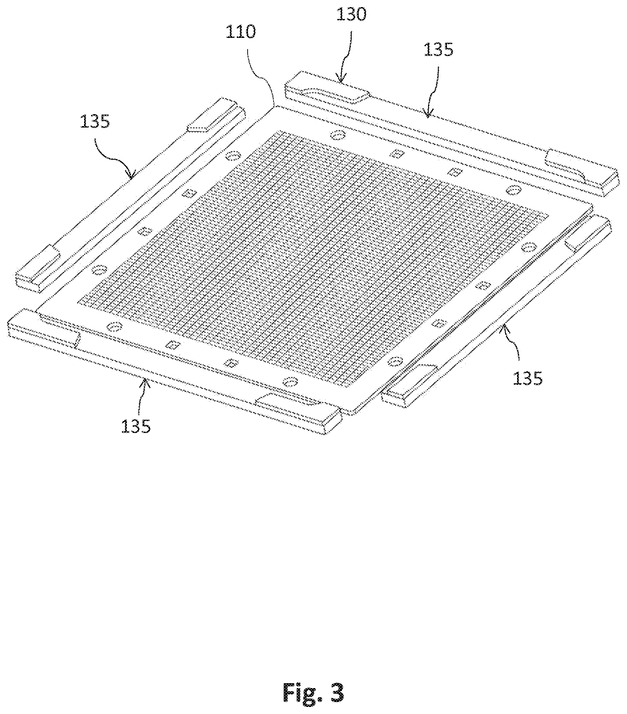

As shown in FIG. 3, the platform 120 may be formed from a plurality of side members 135 arranged around the periphery of the base 110. In the illustrated embodiment, the base 110 has a generally square configuration and the platform 120 includes four side members 135 corresponding to the four sides of the base 110. It will be appreciated, however, that the number and configuration of the side members 135 may vary according to the shape of the base 110.

Each side member 135 may be independently coupled to the base 110 using any suitable removable coupling mechanism, including, without limitation, snap-fit connections, interlocking features, clips, latches, magnets, fasteners, dovetail joints, sliding engagements, or combinations thereof. When the side members 135 are assembled to the base 110, they collectively define the platform 120 surrounding the working area. One or more of the side members 135 may be selectively detached while the remaining side members remain coupled to the base 110, thereby allowing the configuration of the positioning tool assembly to be modified according to the intended application.

In certain embodiments, each side member 135 includes at least a portion of one or more alignment tabs 130. Accordingly, removal of a selected side member 135 also removes the associated alignment feature, thereby providing an unobstructed side of the working area. Such a configuration enables artistic media having dimensions larger than the base 110 or platform 120 to extend beyond the periphery of the assembly while remaining supported within the working area. For example, a sheet of paper, cardstock, fabric, or another artistic medium may extend outwardly through the opening created by the removed side member 135, thereby accommodating larger workpieces without requiring trimming.

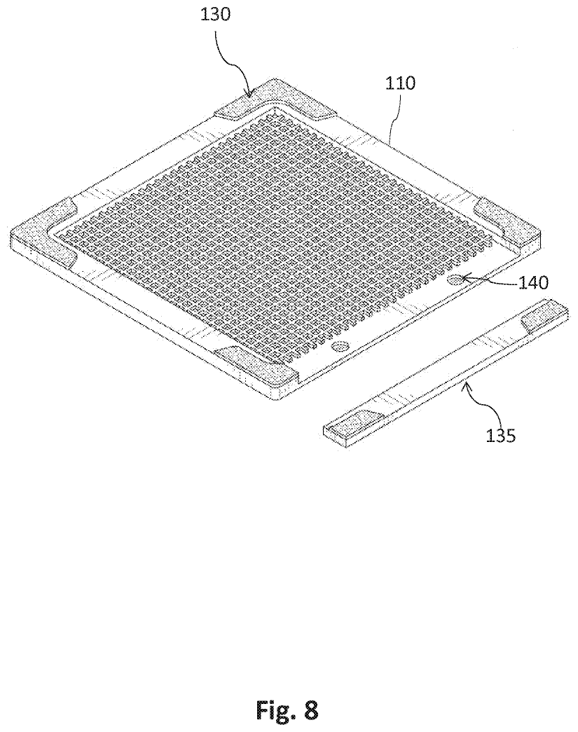

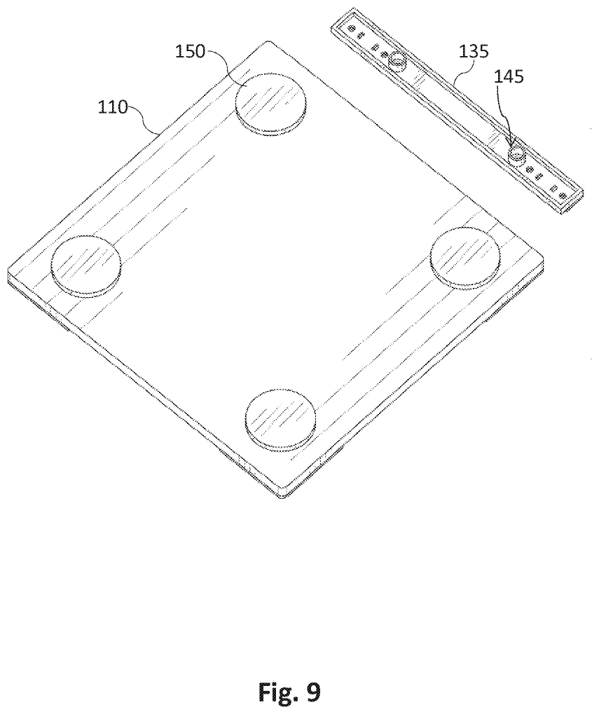

The side members 135 may be removably secured to the base 110 using complementary interlocking fastening features. In one exemplary embodiment, as illustrated in FIGS. 8 and 9, each side member 135 includes one or more projecting plugs 145 configured to be received within corresponding sockets 140 formed in the base 110. Engagement of the plugs 145 with the sockets 140 releasably retains the respective side member 135 in position while permitting removal and reinstallation as desired.

Although plugs 145 and sockets 140 are illustrated, it will be appreciated that other removable fastening arrangements may be employed without departing from the scope of the present disclosure. For example, the side members 135 may be coupled to the base 110 using snap-fit features, interference-fit connections, latches, clips, magnets, threaded fasteners, sliding engagements, dovetail joints, or other releasable coupling mechanisms, or combinations thereof.

As further shown in FIG. 9, the underside of the base 110 may include one or more stopper pads 150. In the illustrated embodiment, four stopper pads 150 are positioned adjacent the respective corners of the base 110. The stopper pads 150 are configured to engage a supporting surface to reduce unintended movement of the positioning tool assembly during use, protect the supporting surface from damage, and provide improved stability. The stopper pads 150 may be formed from rubber, silicone, elastomeric material, foam, or any other suitable material providing frictional engagement with the supporting surface.

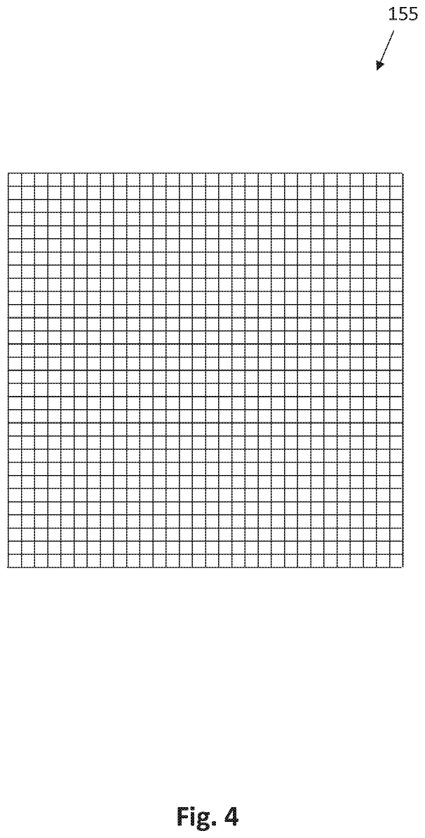

Referring to FIG. 4, shown is an exemplary mounting film 155 configured to be positioned on the base 110 within the working area of the positioning tool assembly. In one embodiment, the mounting film 155 is a photopolymer film suitable for supporting an artistic medium and/or a photopolymer stamp. It will be appreciated, however, that other mounting sheets, mats, adhesive films, or positioning surfaces may alternatively be used.

The mounting film 155 may include a plurality of grid lines or other alignment indicia extending across one or more surfaces thereof. The grid lines facilitate alignment and positioning of an artistic medium, a stamp, a stencil, or other crafting components. The grid lines are optional and may be supplemented or replaced with other visual reference markings, including measurement scales, coordinate markings, angular guides, registration marks, or printed indicia.

The mounting film 155 may be sized and shaped to fit within the recessed working area defined by the base 110 and the surrounding platform 120. In certain embodiments, the mounting film 155 includes an adhesive or tacky surface configured to releasably adhere to the base 110, thereby reducing movement of the mounting film during use while allowing the mounting film to be removed and repositioned when desired.

During use, the artistic medium may be placed on the mounting film 155 and positioned using the grid lines, measurement scales, or other alignment indicia. In embodiments in which the mounting film 155 includes a low-tack adhesive surface, the artistic medium may be releasably retained on the mounting film to reduce unintended movement during stamping, stenciling, or scoring operations. Preferably, the adhesive force is sufficient to hold the artistic medium in place while permitting removal without substantial damage, tearing, or residue. The degree of tackiness may be selected according to the intended application and the type of artistic medium being used.

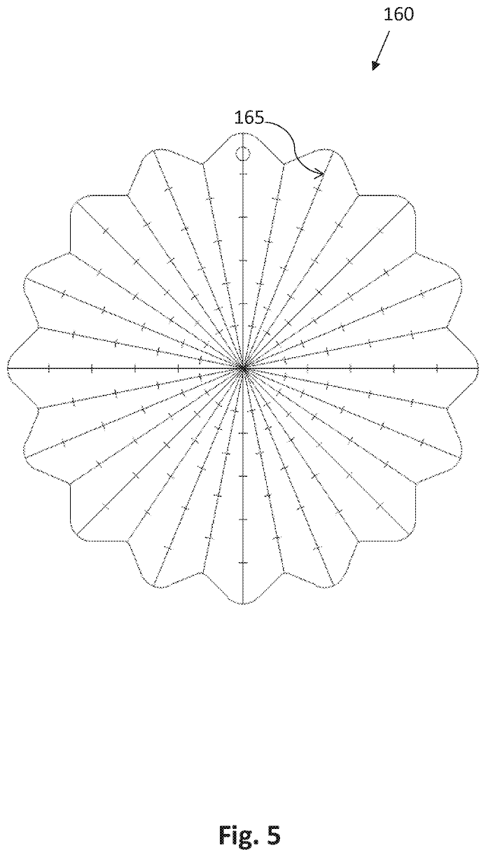

Referring to FIG. 5, shown is an exemplary flip plate 160 configured to cooperate with the platform 120 of the positioning tool assembly. The flip plate 160 is dimensioned to be supported by the platform 120 and is movable between a raised position and a lowered position to facilitate placement and alignment of a stamp, stencil, or other crafting element relative to an artistic medium.

In the illustrated embodiment, the flip plate 160 includes four corner portions configured to be received adjacent the corresponding alignment tabs 130 provided at the corners of the platform 120. Each corner portion of the flip plate 160 may include a rounded profile complementary to the inwardly facing rounded surfaces of the alignment tabs 130. The complementary engagement enables the flip plate 160 to be accurately positioned relative to the platform 120 while substantially limiting lateral movement of the flip plate during use. The flip plate 160 may be lowered onto and lifted from the platform 120 while maintaining repeatable alignment.

In certain embodiments, peripheral portions of the flip plate 160 extend outwardly beyond the outer periphery of the platform 120 to provide grasping regions that facilitate manual lifting, lowering, and repositioning of the flip plate 160. The outwardly extending portions may also improve user access without interfering with the working area of the assembly.

The flip plate 160 may be formed from a transparent or translucent material, such as acrylic, polycarbonate, glass, or another substantially transparent material, thereby allowing a user to view the artistic medium through the flip plate during positioning and stamping operations.

In certain embodiments, the flip plate 160 includes one or more alignment indicia, such as radial lines, grid lines, reference markings, angular markings, measurement scales, or combinations thereof. In one exemplary embodiment, a plurality of radial lines 165 extends generally from a central region toward the periphery of the flip plate 160. The alignment indicia may be etched, printed, engraved, molded, laser-marked, or otherwise formed on or within the flip plate 160. Such alignment indicia facilitate accurate positioning and orientation of a stamp, stencil, or other crafting element relative to the artistic medium and may assist in centering, rotational alignment, or repeated placement.

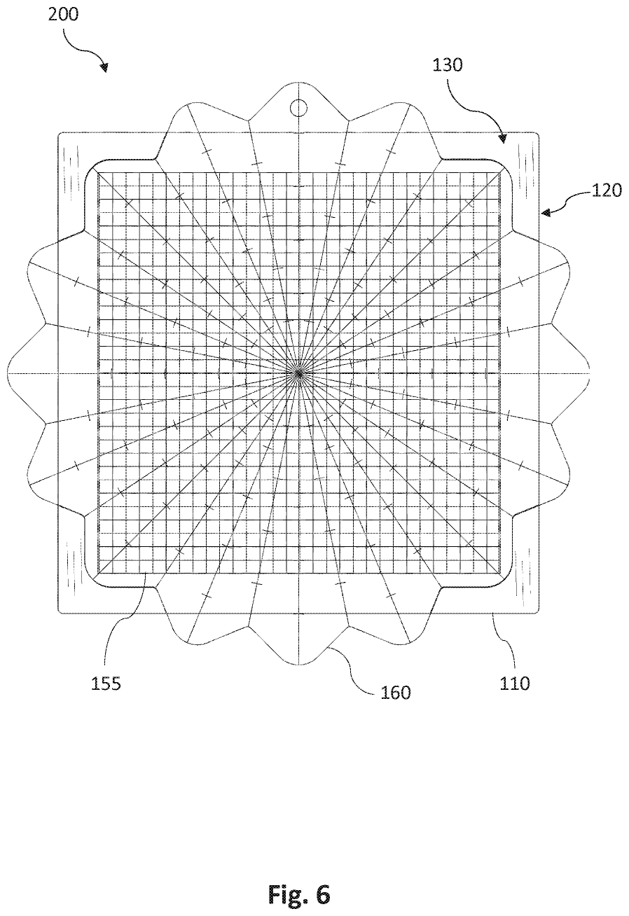

Referring to FIG. 6, shown is an assembled positioning tool assembly 200 including the base 110, the mounting film 155 positioned on the base 110, and the flip plate 160 supported by the platform 120. The positioning tool assembly is configured to facilitate accurate and repeatable positioning of a stamp relative to an artistic medium.

In one exemplary method of use, the mounting film 155 is positioned on the base 110. In embodiments in which the mounting film 155 includes a tacky or adhesive surface, the mounting film 155 may releasably adhere to the base 110 to reduce unintended movement during use. An artistic medium, such as paper, cardstock, a greeting card, or another printable substrate, may then be positioned on the mounting film 155. The artistic medium may be aligned using grid lines, measurement scales, or other alignment indicia provided on the mounting film 155 and/or the positioning tool assembly.

A stamp, such as a photopolymer stamp, may be positioned on a desired location of the artistic medium. Thereafter, the flip plate 160 may be lowered onto the platform 120 with the corner portions of the flip plate aligned relative to the alignment tabs 130. The inner surface of the flip plate 160 contacts the stamp, and light manual pressure may be applied so that the stamp releasably adheres to the inner surface of the flip plate. The flip plate 160 may then be lifted while carrying the stamp in the aligned position.

With the stamp retained on the flip plate 160, a marking composition, such as ink, paint, pigment, embossing medium, or another transferable material, may be applied to the exposed stamping surface of the stamp using an ink pad, roller, brush, sprayer, or any other suitable applicator. The flip plate 160 is subsequently repositioned onto the platform 120, thereby returning the stamp to substantially the same aligned position relative to the artistic medium. Pressure applied to the flip plate transfers the marking composition from the stamp to the artistic medium, producing the desired impression.

If the initial impression is incomplete, non-uniform, or lighter than desired, the flip plate 160 may be lifted while maintaining the stamp in its registered position. Additional marking composition may then be applied to the stamp, after which the flip plate 160 is repositioned on the platform 120 to produce one or more additional impressions at substantially the same location. This repeatable positioning capability enables improved registration between successive stamping operations and reduces the likelihood of image misalignment, ghosting, or double impressions.

Although the foregoing description is directed primarily to the use of a photopolymer stamp, it will be appreciated that the positioning tool assembly may likewise be used with other types of stamps, stencils, templates, or similar image-transfer members without departing from the scope of the present disclosure.

The photopolymer film can be made of any soft material, such as photopolymer that adheres to the surface and resists slip. Any suitable material known to provide grips, such as slip-resistant rubber or silicone can be used. The photopolymer film can adhere to the top surface of the base so that the artistic media does not slip.

In certain embodiments, the positioning tool assembly further includes one or more extension pieces 170 configured to selectively increase the effective working area of the assembly. The extension pieces 170 may be removably coupled to the base 110 to provide additional support for artistic media, stamps, stencils, or other crafting components extending beyond the original dimensions of the base.

In one embodiment, an extension piece 170 is coupled to the base 110 after removal of a corresponding side member 135. The removed side member 135 may then be attached to an outer or distal edge of the extension piece 170 so that the platform 120 and associated alignment features are effectively repositioned outwardly. This arrangement increases the usable workspace while maintaining the functionality of the platform and alignment tabs.

One or more sides of the base 110 may be extended using respective extension pieces 170. The extension pieces may be used individually or in any desired combination, thereby permitting expansion of one side, multiple sides, or substantially the entire perimeter of the base 110 according to the intended application.

The extension pieces 170 may have any suitable size, shape, or configuration and may be identical to or different from one another. For example, an extension piece may have a rectangular, square, semicircular, arcuate, polygonal, or other regular or irregular shape. Likewise, the dimensions of the extension pieces may vary depending on the desired increase in the working area. Such variations are contemplated within the scope of the present disclosure.

In certain embodiments, the extension pieces 170 are removably coupled to the base 110 using the same coupling mechanism employed for attaching the side members 135. For example, the extension pieces 170 may include complementary plugs and sockets, snap-fit features, interlocking members, sliding engagements, magnets, clips, latches, or other releasable fastening mechanisms. Alternatively, the extension pieces may employ coupling mechanisms different from those used for the side members without departing from the scope of the present disclosure.

The positioning tool assembly may be configured to receive any desired number of extension pieces 170 depending on the required working area. In one embodiment, a single extension piece 170 is coupled to one side of the base 110. In other embodiments, two extension pieces 170 are coupled to the base 110, for example, on adjacent sides or on opposite sides. In further embodiments, three extension pieces 170 are coupled to three respective sides of the base 110, or four extension pieces 170 are coupled to all four sides of the base 110. It will be appreciated that any combination of extension pieces may be employed to provide a customized workspace for a particular application.

The extension pieces 170 may be selectively installed or removed independently of one another, thereby allowing the user to configure the positioning tool assembly according to the size and orientation of the artistic medium, the dimensions of a stamp or stencil, or the available work surface. The modular configuration enables the effective working area of the assembly to be expanded only where needed while maintaining the portability and compactness of the assembly when the extension pieces are not in use.

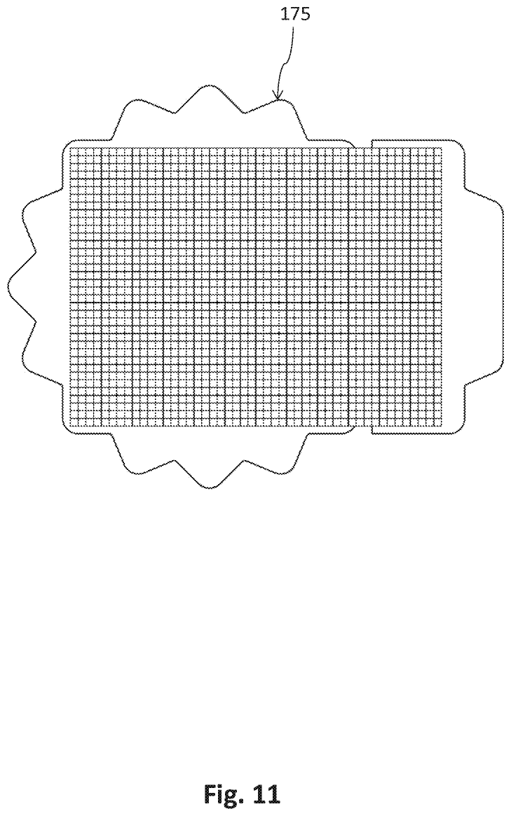

Referring to FIG. 11, the positioning tool assembly may further include one or more extended flip plates 175 configured for use with corresponding extension pieces 170. Each extended flip plate 175 may be dimensioned and configured to cooperate with a particular extension piece or combination of extension pieces so as to maintain accurate positioning and registration over the expanded working area.

Different extended flip plates 175 may be provided for different workspace configurations established by the extension pieces 170. For example, a first extended flip plate may correspond to a single extension piece, while other extended flip plates may correspond to two, three, or more extension pieces arranged in different orientations. It will be appreciated that the size, shape, and configuration of each extended flip plate may vary according to the corresponding expanded workspace.

The extension pieces 170 and the corresponding extended flip plates 175 provide a configurable and expandable workspace suitable for a wide variety of paper crafting and artistic applications. The expanded workspace enables artistic media larger than the original working area to be supported without requiring trimming or resizing. Likewise, larger stamps, stencils, templates, or other image-transfer members may be positioned with greater flexibility and used over an enlarged working surface. The expanded workspace further facilitates stamping, stenciling, or other decorative operations across relatively large artistic media while maintaining accurate alignment and repeatable positioning.

In certain embodiments, the present disclosure further provides a method of using the disclosed positioning tool assembly for stamping an artistic medium. The method includes positioning a mounting film, such as a tacky or adhesive mat, on the base 110 and placing an artistic medium, such as paper, cardstock, or another printable substrate, on the mounting film so that the artistic medium is releasably retained during the stamping operation. Where additional working space is desired, one or more side members 135 of the platform 120 may be removed prior to positioning the artistic medium.

The artistic medium may be aligned at a desired location using one or more alignment indicia provided on the mounting film 155, the base 110, the platform 120, or the flip plate 160. A stamp, such as a photopolymer stamp, may then be positioned at a desired location on the artistic medium. Thereafter, the flip plate 160 or the extended flip plate 175 is lowered onto the platform 120 such that the flip plate is aligned by the alignment tabs 130, allowing the inner surface of the flip plate to releasably engage and retain the stamp. The flip plate 160 or the extended flip plate 175 is subsequently lifted with the stamp attached thereto, and a marking composition, such as ink, paint, pigment, embossing medium, or another transferable material, is applied to the exposed stamping surface.

After application of the marking composition, the flip plate 160 or extended flip plate 175 is repositioned on the platform 120 in registration with the alignment tabs 130. Pressure applied to the flip plate causes the marking composition to be transferred from the stamp onto the artistic medium, thereby forming the desired image or pattern. The flip plate 160 or 175 may then be removed. If a darker, more complete, or otherwise modified impression is desired, the foregoing steps may be repeated while maintaining the alignment of the stamp relative to the artistic medium. Additional stamping operations may likewise be performed using the same or different stamps while preserving accurate positioning. It is to be noted that the frame with the extension piece can be used with the extended flip plate.

In embodiments requiring an expanded working area, one or more side members 135 may be removed from the corresponding sides of the base 110, and one or more extension pieces 170 may be coupled to the base 110 in place of the removed side members. In certain embodiments, the extension pieces 170 utilize the same attachment mechanism as the side members 135. Thereafter, the removed side members 135 may be attached to the outer ends of the extension pieces 170 to re-establish the platform and alignment features at the expanded perimeter. Alternatively, one or more extension pieces 170 may include integral side members or dedicated platform portions, thereby eliminating the need to reinstall the removed side members.

In certain embodiments, the positioning tool assembly may also be used for stenciling operations. A mounting film, such as a tacky or adhesive mat, is positioned on the base 110, and an artistic medium, such as paper, cardstock, fabric, or another printable substrate, is placed on the mounting film so that the artistic medium is releasably retained during the stenciling operation.

Where additional working space is desired, one or more side members 135 of the platform 120 may be removed. If further workspace is required, one or more extension pieces 170 may be coupled to the base 110 to expand the working area. A stencil is then positioned at a desired location on the artistic medium. The tacky surface of the mounting film may releasably retain the artistic medium and, in certain embodiments, the stencil to reduce unintended movement during application of a marking composition.

A marking composition, such as ink, paint, pigment, embossing medium, texture paste, or another transferable material, may be applied over the stencil using any suitable applicator, including an ink-blending tool, sponge, brush, roller, dauber, spray applicator, palette knife, or similar implement. After the marking composition has been applied, the stencil is removed from the artistic medium to reveal the resulting design, pattern, image, or indicia.

The expanded workspace provided by the removable side members 135 and extension pieces 170 enables the positioning tool assembly to accommodate relatively large stencils and artistic media while providing improved access to the work surface and reducing the need to trim or reposition the artistic medium during the stenciling operation.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A positioning tool assembly comprising:
a base defining a working area;
a platform extending around the working area, the platform comprising a plurality of removable side members independently removably coupled to the base, wherein each removable side member is independently detachable from the base; and
a flip plate configured to be supported by the platform and movable between a first position and a second position relative to the working area,
wherein each removable side member comprises one or more alignment features configured to cooperate with the flip plate, the one or more alignment features comprising alignment tabs configured to position the flip plate relative to the base,
wherein removal of one or more of the removable side members increases accessibility to the working area for receiving an artistic medium or an image-transfer member.

2. The positioning tool assembly of claim 1, wherein each removable side member is removably coupled to the base through complementary interlocking members.

3. The positioning tool assembly of claim 2, wherein the complementary interlocking members comprise plugs received within corresponding sockets formed in the base.

4. The positioning tool assembly of claim 1, further comprising at least one extension piece removably attachable to the base after removal of at least one removable side member, wherein the at least one extension piece is configured to increase an effective working area of the assembly.

5. The positioning tool assembly of claim 4, wherein the removed side member is removably attachable to an outer edge of the extension piece.

6. The positioning tool assembly of claim 5, wherein a plurality of extension pieces are removably attachable to corresponding sides of the base.

7. The positioning tool assembly of claim 5, wherein the extension piece is removably coupled to the base through the same coupling mechanism used for attaching the removable side members.

8. The positioning tool assembly of claim 5, further comprising an extended flip plate configured to cooperate with the at least one extension piece.

9. The positioning tool assembly of claim 8, wherein the extended flip plate spans the base and the at least one extension piece to provide a continuous stamping or stenciling workspace.

10. The positioning tool assembly of claim 1, wherein the base comprises an integral score board.

11. A modular positioning tool assembly comprising:
a base;
a plurality of removable side members selectively attachable around the base to define a platform;
at least one extension piece selectively attachable to the base after removal of at least one removable side member;
a flip plate configured to cooperate with the platform; and
an extended flip plate configured to cooperate with the at least one extension piece,
wherein the assembly is selectively reconfigurable between a compact configuration and one or more expanded configurations providing different working areas.

12. A method of positioning an image-transfer member relative to an artistic medium using a positioning tool assembly, the method comprising:
positioning an artistic medium on a base of the positioning tool assembly;
positioning an image-transfer member relative to the artistic medium;
positioning a flip plate on a platform surrounding at least a portion of the base such that the flip plate releasably engages the image-transfer member;
lifting the flip plate with the image-transfer member retained thereon;
applying a marking composition to the image-transfer member;
repositioning the flip plate on the platform to return the image-transfer member to substantially the same position relative to the artistic medium; and
pressing the flip plate to transfer at least a portion of the marking composition from the image-transfer member to the artistic medium.
